(19) United States
(12) Patent Application Publication
(10) Pub. No.: US 2026/0168808 A1
(43) Pub. Date: Jun. 18, 2026

(54) AUTONOMOUS ENCODING AND CANDIDATE ROUTE MAPPING FRAMEWORK

(71) Applicant: OPTUM, INC., Minnetonka, MN (US)

(72) Inventors: Srikanth NITTALA, Bangalore (IN); Raghav NARANG, Hyderabad (IN); Prajakta NAKHATE, Bangalore (IN)

(21) Appl. No.: 18/980,857

(22) Filed: Dec. 13, 2024

(51) Int. Cl. G01C 21/36

(52) U.S. Cl. CPC G01C 21/3667

(57) ABSTRACT

Various embodiments of the present disclosure provide an autonomous encoding and candidate route mapping technique that improves the functionality of a computer in various aspects. The techniques comprise receiving, using a data collection service of a routing pipeline for a graphical user interface, input data from one or more of a plurality of data sources. The techniques comprise generating using an encoding service of the routing pipeline for the graphical user interface, encoded data. The techniques comprise generating, using an optimization service for the graphical user interface, a candidate route mapping by applying a set of weighted hard parameters and a set of weighted soft parameters to the encoded data. The techniques comprise initiating, using a provisioning service of the routing pipeline for the graphical user interface, an update to a real-time view of the graphical user interface based on the candidate route mapping.

### BACKGROUND

Various embodiments of the present disclosure address technical challenges related to traditional candidate route generation techniques. In various domains, computers are tasked with analyzing and interpreting inputs to generate a routes through a virtual environment, such as a map representation of a physical location. Traditional techniques for route mapping are either time intensive, which reduce their efficacy in real time solutions, or rely on limited constraints to improve route timing at the cost of accuracy. These challenges lead to rigid preset structures for route generation in real time applications, which limits the ability to adapt to real-time conditions or customized scenarios, such a carpooling and other real-world circumstances that result in computationally complex sets of variation within a virtual environment.

### BRIEF DESCRIPTION OF THE DRAWINGS

FIG. 1 depicts an example overview of an architecture in accordance with some embodiments of the present disclosure.

FIG. 2 depicts an example predictive data analysis computing entity in accordance with some embodiments of the present disclosure.

FIG. 3 depicts an example client computing entity in accordance with some embodiments of the present disclosure.

FIG. 4 depicts a dataflow diagram of a routing pipeline in accordance with some embodiments of the present disclosure.

FIG. 5 depicts an operational example of example architecture of the optimization service in accordance with some embodiments of the present disclosure.

FIG. 6 depicts a flowchart diagram of an autonomous encoding and candidate route mapping process in accordance with some embodiments of the present disclosure.

### DETAILED DESCRIPTION

Various embodiments of the present disclosure provide virtual mapping techniques that improve the functionality of a computer with respect to various computing tasks, such as autonomous encoding, candidate route mapping, among others. To do so, some embodiments of the present disclosure provide a multi-stage routing pipeline that is integrated into a graphical user interface and defines a plurality of complimentary computing services to first encode inputs of different data types, such as natural language inputs, numerical inputs, tabular inputs, and then leverage the encoding within an automated route mapping generation scheme that is both comprehensive and time efficient for real time applications. To overcome performance deficiencies with traditional route mapping techniques, the multi-stage pipeline implements an encoding service to preemptively reduce processing delays in later stages of the routing pipeline. By doing so, the multi-staged routing pipeline may improve the performance of downstream services of the routing pipeline such that the routing pipeline may be directly integrated within a user interface. This, in turn, enables improved graphical user interfaces for user devices that is capable of displaying route mappings that, unlike traditional techniques, account for inputs in different formats and from a variety of disparate data sources. As described herein, by first encoding these inputs according to a specific coding scheme, the virtual mapping techniques may maintain a high degree of accuracy in route mappings that may be tailored to a particular use case and adapt to real-time conditions while reducing latency of the graphical user interface.

More particularly, traditional virtual routing techniques for user interfaces are limited to candidate route mappings that are derived from inputs configured in rigid preset structures and obtained from a limited number of sources for one general routing use case that is agnostic to domain-specific criteria. In many cases, the rigid preset structures are used by previously onboard data sources, they are not present in real world scenarios and, as a result, are only available from previously onboard data sources. This limits the flexibility, and more specifically the number of data sources available, of inputs available in traditional routing techniques and prevents traditional techniques from accounting for many real-time conditions. The multi-staged routing pipeline of the present disclosure addresses these technical challenges by providing and encoding service and encoding scheme capable of encoding inputs from any data source and/or data type into a format recognized by downstream routing services. By doing so, the multi-staged routing pipeline improves upon the flexibility of traditional routing techniques by addressing a problem specific to computers, namely the aggregation of different data types. This, in turn, improves the mapping functionality of computers among other functionalities expressed through user interfaces.

Moreover, as described in further detail herein, the multi-staged routing pipeline comprises balancing services that leverage encoded inputs from different data sources to generate routes that balance route constraints with other, non-routing related factors. This enables a shift from previously one-dimensional routing services that are unable to balance competing enterprise and routing constraints, to multi-dimensional routing services capable to providing different routes tailored to a particular use case and the nuanced constraints thereof. The multi-stage routing pipeline of the present disclosure, for example, implements an encoding service that autonomously generates encoded data based on inputs from numerous sources in a variety of formats (e.g., natural language-based inputs, numerical based inputs, or tabular inputs). The encoded data may be fed to an optimization service that is designed to use the encoded data to balance numerous competing enterprise constraints and routing constraints to provide an accurate and up to date candidate route mapping within an integrated real-time view of a graphical user interface. Unlike traditional user interface routing mechanisms, the optimization service may generate candidate routing mappings using a configurable set of computer-implemented rules that automatically balance customizable constraints to produce use case-specific routes (e.g., rather than use case-agnostic routes) through a virtual environment rendered via a user interface. This, in turn, improves existing mapping technology by enabling customizable solutions applicable to different use cases without increase timing or processing constraints.

Examples of technologically advantageous embodiments of the present disclosure comprise improved graphical user interfaces and as well as user interface plug-ins that enable improved mapping functionality through improved autonomous encoding and constraint balancing approaches, among other aspects of the present disclosure. Other technical improvements and advantages may be realized by one of ordinary skill.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

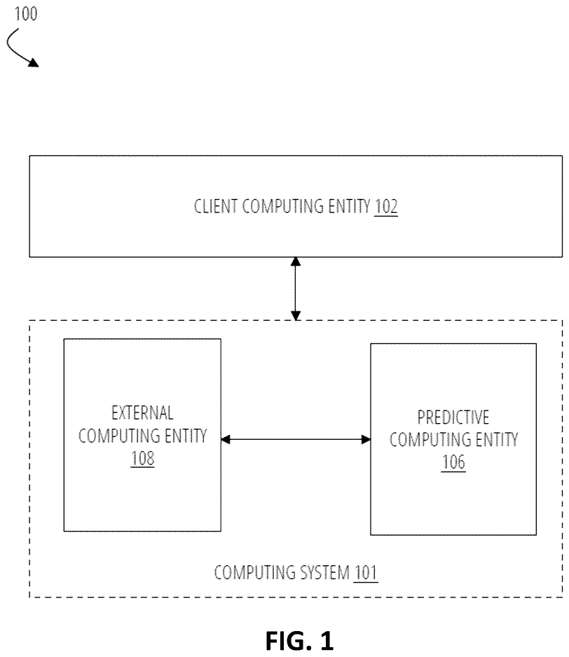

FIG. 1 depicts an example overview of an architecture 100 in accordance with some embodiments of the present disclosure. The architecture 100 comprises a computing system 101 configured to receive data, such as input data, from client computing entities 102, process the input data to generate an output, and provide the output to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models and/or services may be trained and/or configured to generate candidate route mappings, and/or other machine learned outputs. The models may be adapted to an autonomous encoding and candidate route mapping framework comprising a routing pipeline for a graphical user interface having a data collection service, an encoding service, an optimization service, and a provisioning service that may collectively process an input(s) into the routing pipeline to generate encoded information and initiate an update to the graphical user interface based on a candidate route mapping. Some techniques of the present disclosure may adapt traditional models of a cohesive framework, such as an autonomous encoding and candidate route mapping framework, for more efficiently handling portions of an autonomous encoding and candidate route mapping process.

In some embodiments, the computing system 101 may communicate with at least one of the client computing entities 102 using one or more communication networks. Examples of communication networks comprise any wired or wireless communication network comprising, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., encoding techniques) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as input data, encoded data, modification data, and/or the like to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

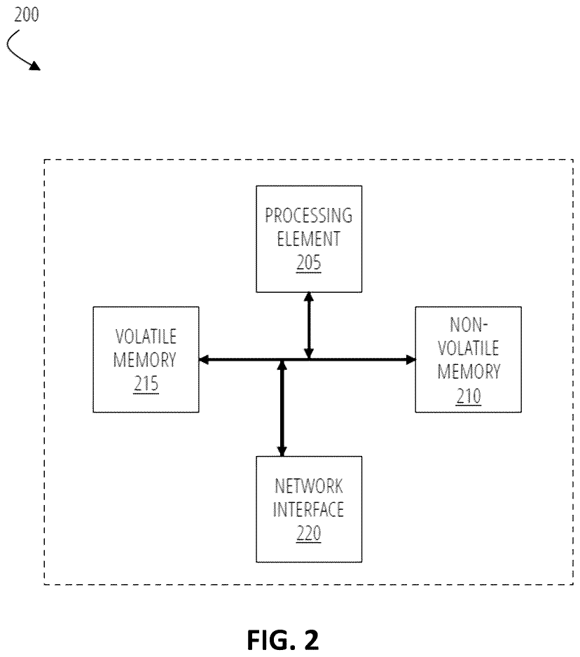

FIG. 2 depicts an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), as discussed above.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium comprising random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (comprising various levels), flash memory, register memory, and/or the like. It will be appreciated that where embodiments are described to use a computer-readable storage medium, other types of computer-readable storage media may be substituted for or used in addition to the computer-readable storage media described above.

As will be recognized, the non-volatile memory 210 and/or the volatile memory 215 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, comprising as computer program products that comprise articles of manufacture. Such computer program products may comprise one or more software components comprising, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (comprising volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

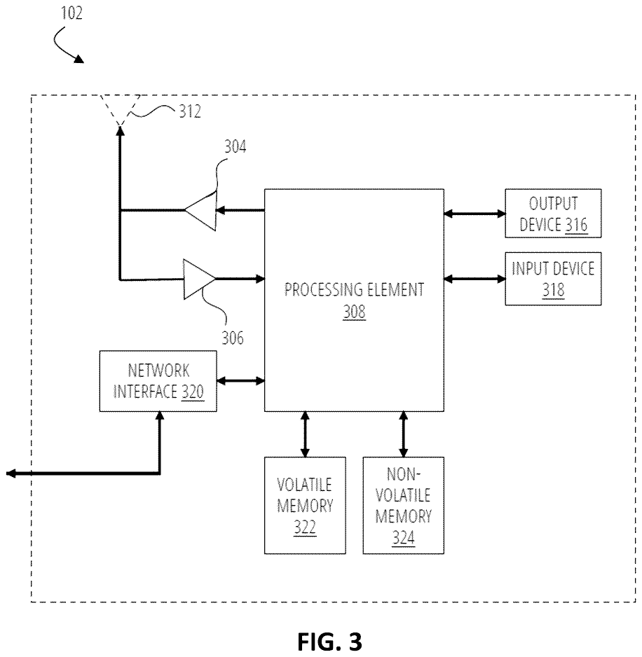

FIG. 3 depicts an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., comprising executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, comprising Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, comprising cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies comprising RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

As indicated, various embodiments of the present disclosure make important technical contributions to graphical user interfaces by presenting user interface plug-ins capable of improved route generation through the use autonomous encoding and optimization processes. In particular, systems and methods are disclosed herein that implement autonomous encoding and candidate route mapping techniques to improve computer interpretation of natural language-based inputs, data processing speed, encoding techniques, and candidate route mapping techniques in various environments, such as high-dimensional computing environments. By doing so, the autonomous encoding and candidate route mapping techniques of the present disclosure enable improved data storage, data processing speeds, and data mapping that, when executed on a computer, improves computer performance, computer encoding speeds, computer candidate route mapping, and computer resource allocation. This, in turn, may improve the functionality of a computer with respect to various computing tasks, comprising data mapping, encoding of natural language-based inputs, data security, network communication, and the like, and results in improved graphical user interfaces as described herein.

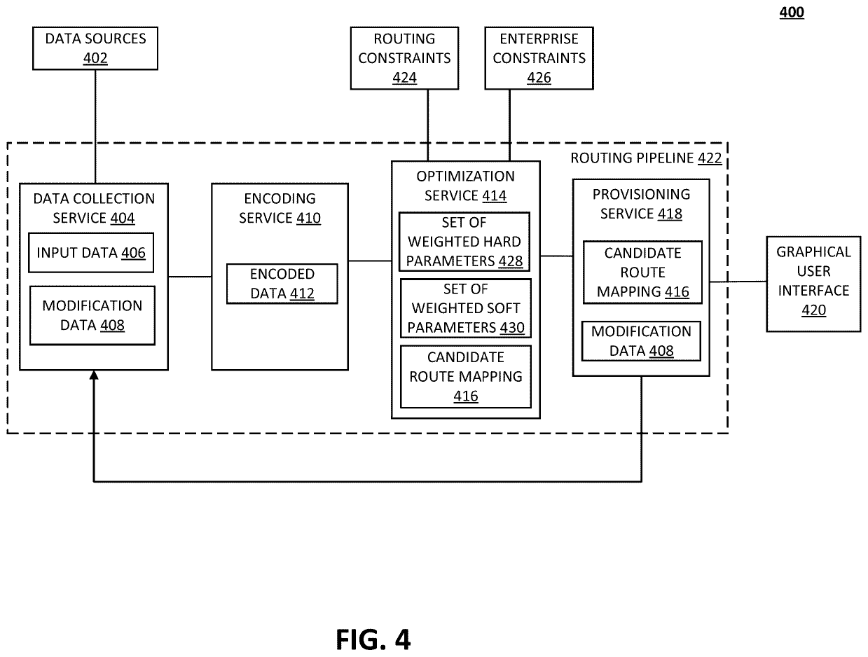

FIG. 4 is a dataflow diagram 400 showing example data structures and modules for autonomous encoding and candidate route mapping in accordance with some embodiments of the present disclosure. The dataflow diagram 400, for example, illustrates a routing pipeline 422 for receiving input data 406, generating encoded data 412 by transforming the input data 406 into a set of input vectors for an optimization service 414 of the routing pipeline 422, generating a candidate route mapping 416 applying a set of weighted hard parameters 428 and a set of weighted soft parameters 430 to the encoded data 412, and initiating, an update to a real-time view of a graphical user interface 420 based on the candidate route mapping 416. The routing pipeline 422 is an ensemble of computing services for a graphical user interface 420. For example, the routing pipeline 422 may be configured to initiate an update to a real-time view of the graphical user interface 420 in response to receiving input data 406 and/or modification data 408. In some embodiments, the routing pipeline 422 comprises one or more of a data collection service 404, an encoding service 410, an optimization service 414, and/or a provisioning service 418. In some embodiments, the ensemble of computing services of the routing pipeline 422 may be organized in sequential processing architecture in which up to each model and/or computing service of the routing pipeline 422 may be implemented as a separate machine learning model, rules-based model, and/or microservice. In this way, the autonomous encoding and candidate route mapping framework improves the performance of computers, systems, machine learning models, and/or the like associated with autonomous encoding and candidate route mapping process.

In some embodiments, the computing system 101, using the optimization service 414 of the routing pipeline 422 for the graphical user interface 420, receives routing constraints 424. In some embodiments, the routing constraints 424 comprise a plurality of constraints on generating the candidate route mapping 416 that are associated with routing one or more of a plurality of users. For example, the routing constraints 424 may comprise a plurality of constraints on generating the candidate route mapping 416 that are associated with routing a first user to a second user location.

In some embodiments, the routing constraints 424 comprise a movement time constraint, an occurrence constraint, second user constraint, distance constraint, a timing constraint, a grouping constraint, and/or the like. In some embodiments, a movement time constraint is indicative of a maximum amount of time that a first user spends traveling between one or more second user locations and/or from a first user location to one or more second user locations based on the candidate route mapping 416. In some embodiments, an occurrence constraint is indicative of a minimum number of times that a first user is routed to one or more second user locations based on the candidate route mapping 416. In some embodiments, a second user constraint is indicative of a maximum number of second users that at least one first user is not routed to based on the candidate route mapping 416. In some embodiments, a distance constraint is indicative of a maximum amount of geographic distance that a first user is routed based on the candidate route mapping 416. In some embodiments, a timing constraint is indicative of a maximum number of times that a first user is routed to a second user location such that the first user arrives at the second user location outside of a particular time window based on the candidate route mapping 416. In some embodiments, a grouping constraint is a minimum number of times that a first user and another first user are routed such that the first user and the second user are able to travel together to a second user location based on the candidate route mapping 416.

In some embodiments, the computing system 101, using the optimization service 414 of the routing pipeline 422 for the graphical user interface 420, receives enterprise constraints 426. In some embodiments, the enterprise constraints 426 comprise a plurality of constraints on generating the candidate route mapping 416 that are associated with orchestrating the routing of one or more of a plurality of users by an enterprise. In some embodiments, an enterprise is a particular entity and/or one or more users associated with a particular entity. For example, an enterprise may be an entity associated with a software development domain and/or a healthcare domain.

In some embodiments, the enterprise constraints 426 comprise a repeat constraint, an open time constraint, an active time constraint, a priority constraint, an urgent constraint, and/or the like. In some embodiments, a repeat constraint is indicative of a preference for routing a first user to a second user based on the candidate route mapping 416 if the first user has been previously routed to the second user (e.g., previously routed to the second user based on a historical candidate route mapping). In some embodiments, an open time constraint is a minimum amount of time that a first user is not being routed to a second user location and/or not located at second user location during a time window in which the first user is active based on the candidate route mapping 416. In some embodiments, an active time constraint is a maximum amount of time that a first user is active based on the candidate route mapping 416. In some embodiments, a priority constraint is indicative of a priority score associated with a second user that is used to order the routing of one or more first users to a second user location based on the candidate route mapping 416. In some embodiments, an urgent constraint is indicative of a preference to route a first user to a second user location when a second user and/or input data 406 indicates that it is urgent that a first user be routed to the second user location.

In some embodiments, the computing system 101, using the optimization service 414 of the routing pipeline 422 for the graphical user interface 420, generates a set of weighted hard parameters 428 and/or a set of weighted soft parameters by applying a weight to up to each of the routing constraints 424 and/or the enterprise constraints 426. In some embodiments, a weight is a classification that is applied to a routing constraint and/or an enterprise constraint. In some embodiments, a weight is a hard weight. In this regard, in some embodiments, if a hard weight is applied to a routing constraint and/or an enterprise constraint, then the routing constraint and/or an enterprise constraint is a constraint that is required to be adhered to when generating the candidate route mapping 416. For example, if a hard weight is applied to an occurrence constraint, the optimization service 414 is prevented from generating a candidate route mapping 416 that instructs a first user to be routed to one or more second user locations less than the minimum number of times indicated by the occurrence constraint.

In some embodiments, a weight is a soft weight. In this regard, in some embodiments, if a soft weight is applied to a routing constraint and/or an enterprise constraint, then the routing constraint and/or an enterprise constraint is a constraint that is considered when generating the candidate route mapping 416 but is not required to be adhered to when generating the candidate route mapping 416. For example, a constraint associated with a soft weight may not be adhered to when it is not possible to satisfy a constraint associated with a hard weight while also adhering to the constraint associated with the soft weight.

In some embodiments, a set of weighted hard parameters 428 comprises a first constraint combination. In some embodiments, the first constraint combination comprises one or more of the routing constraints 424 associated with a hard weight and one or more of the enterprise constraints 426 associated with a soft weight. For example, set of weighted hard parameters 428 may comprise an urgent constraint.

In some embodiments, a set of weighted soft parameters 430 comprises a second constraint combination. In some embodiments, the first constraint combination comprises one or more of the routing constraints 424 associated with a soft weight and one or more of the enterprise constraints 426 associated with a soft weight. For example, the set of weighted soft parameters 430 may comprise an active time constraint.

In some embodiments, the computing system 101, using a data collection service 404 of the routing pipeline 422 for the graphical user interface 420, receives input data from one or more data sources 402. In some embodiments, input data 406 comprises one or more items of data that are input into the routing pipeline 422 to generate the candidate route mapping 416. In some embodiments, the input data 406 comprises one or more items of data indicative of one or more temporal features, geographic features, navigation features, user features, and/or entity features. In some embodiments, the input data 406 is configured in a natural language format. For example, the input data 406 may comprise a segment of text, such as “a first user is available between a first time and a second time” Additionally, or alternatively, the input data 406 is configured in a numerical format. For example, the input data 406 may comprise one or more numbers that indicate the availability of a first user as “9-5”. Additionally, or alternatively, the input data 406 is configured in a tabular format. For example, the input data 406 may comprise a table having one or more data fields indicating the availability of a first user.

In some embodiments, the data sources 402 are locations which are accessible by one or more computing devices for retrieval and storage of data associated with the routing pipeline 422. In some embodiments, the data sources 402 may be a database stored on a memory device and/or a database operated by a microservice associated with one or more first users. In this regard, for example, the data sources 402 may be configured to receive data from one or more first users, such as via a user interface of a mobile application accessible by one or more first users. In some embodiments, the data sources 402 may be a database stored on a memory device and/or a database operated by a microservice associated with one or more second users. In this regard, for example, the data sources 402 may be configured to receive data from one or more second users, such as via a user interface of a mobile application accessible by one or more second users. In some embodiments, the data sources 402 may be a database stored on a memory device and/or a database operated by a microservice associated with a navigational mapping and traffic monitoring provider. In some embodiments, the data sources 402 may be a database stored on a memory device and/or a database operated by a microservice associated with one or more other data providers, such as a public transportation data provider, a weather forecast provider, third users, and/or the like. In some embodiments, the data sources 402 are configured to store and/or provide input data 406, modification data 408, encoded data 412, and/or candidate route mapping 416. The data sources 402 may be dynamically updated or be static. In some embodiments, the data sources 402 are encrypted in order to limit unauthorized access of data associated with the routing pipeline 422.

In some embodiments, the data collection service 404 is a data entity that describes parameters, hyper-parameters, and/or defined operations of a rules-based and/or machine learning model (e.g., model comprising at least one of one or more rule-based layers, one or more layers that depend on trained parameters, coefficients, and/or the like). The data collection service 404 may be configured, trained, and/or the like to receive input data 406 and/or modification data 408. For example, the data collection service 404 may be configured, trained, and/or the like to receive input data 406 and/or modification data 408 from the data sources 402. As another example, the data collection service 404 may be configured, trained, and/or the like to receive modification data 408 from the provisioning service 418. In some embodiments, the data collection service 404 uses a framework, such as Spring Boot, for receiving input data 406 and/or modification data 408. For example, the data collection service 404 may use a framework to receive input data 406 and/or modification data 408 from REST APIs, JPA repositories, Kafka messaging systems, and/or the like associated with the data sources 402 and/or the provisioning service 418. In some embodiments, the data collection service 404 is configured, trained, and/or the like to receive real-time input data 406 and/or real-time modification data 408. For example, the data collection service 404 is configured, trained, and/or the like to receive real-time modification data 408 from the provisioning service 418 that has been provided by a first user via the graphical user interface 420. Additionally, or alternatively, data collection service 404 is configured, trained, and/or the like to receive static input data 406 and/or static modification data 408. In some embodiments, the data collection service 404 is a first portion of the routing pipeline 422.

In some embodiments, the computing system 101, using an encoding service 410 of the routing pipeline 422 for the graphical user interface 420, generates encoded data 412 by transforming the input data into a set of input vectors for the optimization service 414. In some embodiments, encoded data 412 comprises one or more items of data that are input into an optimization service 414 of the routing pipeline 422. In some embodiments, encoded data 412 is indicative of a set of input vectors that are input into the optimization service 414. In some embodiments, an input vector is a data structure that is representative of at least a portion of the input data 406 structured such that it may be processed by the optimization service 414. In this regard, for example, an input vector may be a one dimensional or multidimensional vector that comprises one or more of a temporal feature, a normalized temporal feature, an indicator, an identifier, a geographic feature, a geographic value, a tuple, a navigation feature, a navigation code, a route segment, a user feature, a workflow code, an entity feature, a temporal value, a temporal unit, a temporal code, a user code, and/or the like structured such that it may be processed by the optimization service 414.

In some embodiments, the encoding service 410 is a data entity that describes parameters, hyper-parameters, and/or defined operations of a rules-based and/or machine learning model (e.g., model comprising at least one of one or more rule-based layers, one or more layers that depend on trained parameters, coefficients, and/or the like). The encoding service 410 may be configured, trained, and/or the like to generate encoded data 412. For example, the encoding service 410 may be configured, trained, and/or the like to generate encoded data 412 by transforming input data 406 and/or modification data 408 into a set of input vectors for the optimization service 414. In some embodiments, the encoding service 410 is configured, trained, and/or the like to receive input data 406 from the data collection service 404 and provide encoded data 412 to the optimization service 414. In some embodiments, the encoding service 410 is configured, trained, and/or the like to generate encoded data 412 in response to receiving input data 406 and/or modification data 408. For example, the encoding service 410 may be configured, trained, and/or the like to generate encoded data 412 in response to receiving input data 406 and/or generate second encoded data in response to receiving modification data 408. In some embodiments, the encoding service 410 is a second portion of the routing pipeline 422.

In some embodiments, to generate encoded data the computing system 101, using the encoding service 410, extracts a temporal feature from the input data. In some embodiments, the temporal feature is associated with a first user of the plurality of users.

In some embodiments, a temporal feature is a data structure that describes an amount of time, a time period, a time window, time slots, and/or the like. In some embodiments, a temporal feature may be indicative of an amount of time, a time period, a time window, time slots, and/or the like in which a first user is available to be routed to one or more second user locations based on the candidate route mapping 416. Additionally, or alternatively, a temporal feature may be indicative of an amount of time, a time period, a time window, time slots, and/or the like in which a second user is available at a second user location such that a first user may be routed to the second user location based on the candidate route mapping 416. Additionally, or alternatively, a temporal feature may be indicative of an amount of time, a time period, a time window, time slots, and/or the like associated with an entity feature. Additionally, or alternatively, a temporal feature may be indicative of a time period in which a third user is located at a second user location, such as a morning time period, an afternoon time period, and/or an evening time period. In a healthcare domain context, for example, a temporal feature may be indicative of a time period in which a field agent is available to be routed to a healthcare provider and/or a time slot in which a healthcare provider is available such that a field agent may be routed to the healthcare provider.

A temporal feature may be defined and/or comprised in input data 406 provided in the routing pipeline 422. In this regard, for example, input data 406 may define a temporal feature that indicates that a first user is available between a 9 AM and 5 PM time period to be routed to one or more second user locations based on the candidate route mapping 416. As another example, input data 406 may define a temporal feature that indicates that a second user is available at a 10 AM time slot, a 1 PM time slot, and a 3 PM time slot at a second user location such that a first user may be routed to the second user location based on the candidate route mapping 416.

In some embodiments, a first user is an individual that is routed to one or more second user locations based on a candidate route mapping 416. In some embodiments, a first user is associated with a first user location. A first user location, for example, may be a geographic location at which a first user is physically located when the candidate route mapping 416 is generated. In some embodiments, a first user identifier is a data structure that uniquely identifies a first user in the candidate route mapping 416. In some embodiments, the candidate route mapping 416 is associated with a plurality of first users. For example, the candidate route mapping 416 may comprise a plurality of first user locations and a plurality of first user identifiers. By way of example, with reference to a healthcare domain, a first user may be a field agent.

In some embodiments, a second user is an individual that is associated with one or more second user locations that one or more first users are routed to based on the candidate route mapping 416. In some embodiments, a second user is associated with a second user location. A second user location, for example, may be a geographic location at which a second user is physically located when the candidate route mapping 416 is generated and/or a geographic location at which a second user provides one or more services to a third user. In some embodiments, a second user identifier is a data structure that uniquely identifies a second user in the candidate route mapping 416. In some embodiments, the candidate route mapping 416 is associated with a plurality of second users. For example, the candidate route mapping 416 may comprise a plurality of second user locations and a plurality of second user identifiers. By way of example, with reference to a healthcare domain, a second user may be a healthcare provider.

In some embodiments, a third user is an individual that is provided with one or more services by a second user. In some embodiments, a third user is associated with a second user location. In some embodiments, the candidate route mapping 416 is associated with a plurality of third users. By way of example, with reference to a healthcare domain, a third user may be a patient. In some embodiments, a plurality of users comprises first users, second users, third users, and/or one or more other users.

In some embodiments, to generate encoded data the computing system 101, using the encoding service 410, generates a normalized temporal feature by converting a temporal feature to a temporal format. In some embodiments, a normalized temporal feature is a data structure that describes a temporal feature that has been normalized to a temporal format. In this regard, in some embodiments, a normalized temporal feature may be indicative of an amount of time, a time period, a time window, time slots, and/or the like in which a first user is available to be routed to one or more second user locations based on the candidate route mapping 416 that has been normalized to the temporal format. Additionally, or alternatively, a normalized temporal feature may be indicative of an amount of time, a time period, a time window, time slots, and/or the like in which a second user is available at a second user location such that a first user may be routed to the second user location based on the candidate route mapping 416 that has been normalized to the temporal format. In some embodiments, the temporal format is a 24-hour time format. For example, if a temporal feature indicates that a first user is available between a 9 AM and 5 PM time period to be routed to one or more second user locations based on the candidate route mapping 416, a corresponding normalized temporal feature may indicate that a first user is available between a 09:00 to 17:00 time period to be routed to one or more second user locations based on the candidate route mapping 416.

In some embodiments, generating encoded data using a first encoding technique comprises the computing system 101 being configured to, using the encoding service 410, generates a plurality of indicators based on the normalized temporal feature. In some embodiments, the plurality of indicators comprises a set of positive indicators and a set of negative indicators. In some embodiments, an indicator is a data structure that describes a Boolean value associated with a normalized temporal feature. In some embodiments, an indicator is a positive indicator that is indicative of a true Boolean value (e.g., 1). In some embodiments, an indicator is a negative indicative that is indicative of a false Boolean value (e.g., 0). In some embodiments, a plurality of indicators may be indicative of a normalized temporal feature. For example, if a normalized temporal feature indicates that a first user is available between a 09:00 to 17:00 time period to be routed to one or more second user locations based on the candidate route mapping 416, a plurality of indicators may comprise 9 positive indicators (e.g., a set of positive indicators) with up to each of the nine positive indicators indicative of 1 hour in the 09:00 to 17:00 time period and 13 negative indicators (e.g., a set of negative indicators) with up to each negative indicator indicative of 1 hour of a day outside the 09:00 to 17:00 time period.

In some embodiments, to generate encoded data the computing system 101, using the encoding service 410, generates a first input vector of a set of input vectors. In some embodiments, the first input vector comprises a set of positive indicators and a set of negative indicators. In this regard, in some embodiments, the computing system 101 is configured to generate an input vector of the set of input vectors for the optimization service 414 that comprises a set of positive indicators and a set of negative indicators in response to extracting a temporal feature from the input data 406.

In some embodiments, to generate encoded data the computing system 101, using the encoding service 410, extracts a first temporal feature, a second temporal feature, and a location geographic feature from the input data 406. In some embodiments, a geographic feature is a data structure that describes a geographic related description of a second user location. For example, a geographic feature may be a geographic related description that describes a second user location as Location X. In the healthcare domain context, for example, a geographic feature may be a geographic related description of the location of a healthcare provider, such as a geographic related description that describes a healthcare provider location as Clinic A. Additionally, or alternatively, a geographic feature is a data structure that describes a geographic related description of a first user location. For example, a geographic feature may be a geographic related description of a first user location that describes a street (e.g., “Main Street”) that corresponds to a first user location, a zip code that corresponds to a first user location (e.g., “12345”), an area that corresponds to a user location (e.g., “southeastern part of a city”), and/or the like. In the healthcare domain context, for example, a geographic feature may be a geographic related description of the location of a field agent, such as geographic related description that describes a field agent location as Main Street. Additionally, or alternatively, a geographic feature is a data structure that describes a geographic related description of a path between a first user location and a second user location. For example, a geographic feature may be a geographic related description of a path between a first user location and a second user location as Side Street (e.g., Side Street being a road that may be used to travel from a first user location to a second user location). A geographic feature may be defined and/or comprised in input data 406 provided in the routing pipeline 422.

In some embodiments, to generate encoded data the computing system 101, using the encoding service 410, applies a first identifier to the first temporal feature and a second identifier to the second temporal feature. In some embodiments, an identifier is a data structure that describes a unique identifier for a time slot in which a second user is available at a second user location such that a first user may be routed to the second user location based on the candidate route mapping 416. For example, if a temporal feature indicates that a second user is available at a 10 AM time slot, a 1 PM time slot, and a 3 PM time slot at a second user location such that a first user may be routed to the second user location based on the candidate route mapping 416, a first identifier may uniquely identify the 10 AM time slot, a second identifier may uniquely identify the 1 PM time slot, and a third identifier may uniquely identify the 3 PM time slot.

In some embodiments, to generate encoded data the computing system 101, using the encoding service 410, generates a geographic value based on a geographic feature. In some embodiments, geographic value is a data structure that describes a geographic location of a second user location. For example, a geographic value may be the latitude and longitude of a second user location. As another example, a geographic value may be an address of a second user location. In the healthcare domain context, for example, a geographic value may be a geographic location of a healthcare provider, such as a geographic location that indicates the latitude and longitude of a healthcare provider location and/or an address of a healthcare provider location. In some embodiments, a geographic value is generated based on a geographic feature using geocoding.

In some embodiments, to generate encoded data the computing system 101, using the encoding service 410, generates a first input vector of a set of input vectors. In some embodiments, the first input vector comprises a first tuple comprising the first identifier and the geographic value and a second tuple comprising the second identifier and the geographic value. In some embodiments, a tuple is a data structure that comprises an identifier and a related geographic value. For example, a tuple may be a data structure that comprises (1) an identifier that uniquely identifies a time slot in which a second user is available at a second user location such that a first user may be routed to the second user location based on the candidate route mapping 416 and (2) a geographic value that indicates a geographic location of a second user location. In this regard, in some embodiments, the computing system 101 is configured to generate an input vector of the set of input vectors for the optimization service 414 that comprises a first tuple and a second tuple in response to extracting a first temporal feature, a second temporal feature, and a geographic feature from the input data 406.

In some embodiments, to generate encoded data the computing system 101, using the encoding service 410, extracts a navigation feature and a geographic feature from the input data 406. In some embodiments, a navigation feature is a data structure that describes an event that impacts the amount of time it takes for a first user to travel from a first user location to a second user location. For example, a navigation feature may be traffic that increases the amount of time it takes for a first user to travel from a first user location to a second user location. In some embodiments, a navigation feature corresponds to a geographic feature. For example, a navigation feature may indicate that a particular road has traffic. A navigation feature may be defined and/or comprised in input data 406 provided in the routing pipeline 422.

In some embodiments, to generate encoded data the computing system 101, using the encoding service 410, applies a navigation code to a navigation feature. In some embodiments, a navigation code is a data structure that describes a classification of a navigation feature. For example, the navigation code may be indicative of a low classification of a navigation feature when the navigation feature makes a minimal impact to the amount of time it takes for a first user to travel from a first user location to a second user location. As another example, the navigation code may be indicative of a moderate classification of a navigation feature when the navigation feature makes a moderate impact to the amount of time it takes for a first user to travel from a first user location to a second user location. As another example, the navigation code may be indicative of a severe classification of a navigation feature when the navigation feature makes a severe impact to the amount of time it takes for a first user to travel from a first user location to a second user location.

In some embodiments, to generate encoded data the computing system 101, using the encoding service 410, determines a route segment associated with a geographic feature. In some embodiments, a route segment refers to a data structure that describes a portion of a path between one or more user locations. For example, a route segment may be a portion of a path between a first user location and a second user location that is indicated in the candidate route mapping 416. In some embodiments, a route segment is associated with a geographic feature. For example, if a geographic feature is a geographic related description of a first user location that describes a street, a route segment may be a portion of the street.

In some embodiments, to generate encoded data the computing system 101, using the encoding service 410, generates a first input vector of a set of input vectors. In some embodiments, the first input vector comprises a navigation code and a route segment. In this regard, in some embodiments, the computing system 101 is configured to generate an input vector of the set of input vectors for the optimization service 414 that comprises a navigation code and a route segment in response to extracting a navigation feature and a geographic feature from the input data 406.

In some embodiments, to generate encoded data the computing system 101, using the encoding service 410, extracts a first user feature and a second user feature from the input data 406. In some embodiments, the first user feature is associated with a first user and the second user feature is associated with a second user. In some embodiments, a user feature is a data structure that describes a characteristic associated with a first user. For example, a user feature may be indicative of a qualifications of the first user. In a healthcare domain context, for example, a user feature may be indicative of a general care qualification, a pediatrics qualification, a geriatrics qualification, and/or the like associated with a first user. In some embodiments, a user feature is a data structure that describes a characteristic associated with a third user. In a healthcare domain context, for example, a user feature may be indicative of a wheelchair use associated with a third user. A user feature may be defined and/or comprised in input data 406 provided in the routing pipeline 422.

In some embodiments, to generate encoded data the computing system 101, using the encoding service 410, applies a first workflow code to a first user feature and a second workflow code to a second user feature. In some embodiments, a workflow code is a data structure that uniquely identifies a user feature. For example, a workflow code may be a numerical code that identifies a particular user feature associated with a first user.

In some embodiments, to generate encoded data the computing system 101, using the encoding service 410, generates a first input vector of a set of input vectors. In some embodiments, the first input vector comprises a first workflow code and a second workflow code. In this regard, in some embodiments, the computing system 101 is configured to generate an input vector of the set of input vectors for the optimization service 414 that comprises a first workflow code and a second workflow code in response to extracting a first user feature and a second user feature from the input data 406.

In some embodiments, to generate encoded data the computing system 101, using the encoding service 410, extracts an entity feature and a temporal feature associated with the entity feature from the input data 406. In some embodiments, an entity feature is a data structure that describes a type of action performed by a second user. In a healthcare domain context, for example, an entity feature may be indicative of a type of appointment that a healthcare provider may provide to a third user, such as a general check-up appointment, a home therapy appointment, and/or the like. An entity feature may be defined and/or comprised in input data 406 provided in the routing pipeline 422.

In some embodiments, to generate encoded data the computing system 101, using the encoding service 410, generates a temporal value for the entity feature by applying a temporal unit to a temporal feature. In some a temporal unit is a data structure that describes a standard unit of time that is associated with an entity feature. For example, a standard unit of time may be 15 minutes. In some embodiments, a temporal value is a data structure that describes a number of temporal units associated with an entity feature. For example, if it takes 1 hour for a second user to perform a type of action associated with an entity feature and the standard unit of time of a temporal unit is 15 minutes, the temporal value associated with the entity feature is 4.

In some embodiments, to generate encoded data the computing system 101, using the encoding service 410, generates a first input vector of a set of input vectors. In some embodiments, the first input vector comprises an entity feature and a temporal value. In this regard, in some embodiments, the computing system 101 is configured to generate an input vector of the set of input vectors for the optimization service 414 that comprises an entity feature and a temporal value in response to extracting an entity feature and a temporal feature associated with the entity feature from the input data 406.

In some embodiments, to generate encoded data the computing system 101, using the encoding service 410, extracts a user feature and a temporal feature associated with the user feature from the input data 406.

In some embodiments, to generate encoded data the computing system 101, using the encoding service 410, generates a temporal code based on a temporal feature. In some embodiments, a temporal code comprises a data structure that describes a code that uniquely identifies a time period in which a third user is located at a second user location. For example, a first temporal code may uniquely identify a morning time period, a second temporal code may uniquely identify an afternoon time period, and a third temporal code may uniquely identify an evening time period.

In some embodiments, to generate encoded data the computing system 101, using the encoding service 410, generates a user code based on a user feature. In some embodiments, a user code is a data structure that describes a code that uniquely identifies a characteristic of a third user. For example, a first user code may uniquely identify wheelchair use by a third user.

In some embodiments, to generate encoded data the computing system 101, using the encoding service 410, generates a first input vector of a set of input vectors. In some embodiments, the first input vector comprises a temporal code and a user code. In this regard, in some embodiments, the computing system 101 is configured to generate an input vector of the set of input vectors for the optimization service 414 that comprises a temporal code and a user code in response to extracting a user feature and a temporal feature associated with the user feature from the input data 406.

In some embodiments, the computing system 101, using the optimization service 414 of the routing pipeline 422 for the graphical user interface 420, generates the candidate route mapping 416 by applying the set of weighted hard parameters 428 and the set of weighted soft parameters 430 to the encoded data 412. In some embodiments, the candidate route mapping 416 is generated in response to the data collection service 404 receiving input data 406 and/or modification data 408. In some embodiments, the candidate route mapping 416 is a data structure that is configured to be rendered on a real-time view of the graphical user interface 420. In some embodiments, the candidate route mapping 416 comprises one or more user identifiers that each correspond to one of a plurality of users. For example, the candidate route mapping 416 may comprise a first user identifier corresponding to a first user and a second user identifier corresponding to a second user. In some embodiments, the candidate route mapping 416 comprises a representation of one or more user locations. For example, the candidate route mapping 416 may comprise a first representation of a first user location and/or a second representation of a second user location.

In some embodiments, the candidate route mapping 416 comprises one or more navigational instructions. In some embodiments, a navigational instruction identifies a path between one or more user locations. For example, a navigational instruction may identify a path between a first user location and a second user location. In this regard, for example, a navigational instruction may provide a first user a route to travel to one or more second user locations.

In some embodiments, the candidate route mapping 416 comprises a time corresponding to the navigational instruction. The time may be indicative of an amount of time it will take a user to travel a path between one or more user locations identified in the candidate route mapping 416. For example, the candidate route mapping 416 may identify a first path between a first user location and a second user location and a first time that indicates an amount of time for a first user to travel between the first user location and the second user location via the first path. Additionally, or alternatively, the time may be indicative of a time at which a user should arrive at one or more user locations identified in the candidate route mapping 416. For example, the candidate route mapping 416 may identify a time at which a first user should arrive at a second user location. Additionally, or alternatively, the time may be indicative of an amount of time a user should spent at a user location identified in the candidate route mapping 416. For example, the candidate route mapping 416 may identify a time that indicates the amount of time a first user should spent at a second user location.

In some embodiments, the optimization service 414 is a data entity that describes parameters, hyper-parameters, and/or defined operations of a rules-based and/or machine learning model (e.g., model comprising at least one of one or more rule-based layers, one or more layers that depend on trained parameters, coefficients, and/or the like). The optimization service 414 may be configured, trained, and/or the like to generate a candidate route mapping 416. In some embodiments, the optimization service 414 is configured to receive encoded data 412 from the encoding service 410 and provide a candidate route mapping 416 to the provisioning service 418. In some embodiments, the optimization service 414 is a third portion of the routing pipeline 422.

In some embodiments, the computing system 101, using the provisioning service 418 of the routing pipeline 422 for the graphical user interface 420, initiates an update to a real time view of the graphical user interface 420 based on the candidate route mapping. In some embodiments, the computing system 101 initiates an update to a real-time view of the graphical user interface 420 in response to generation of the candidate route mapping 416. For example, initiating an update to a real-time view of the graphical user interface 420 based on the candidate route mapping 416 comprises the computing system 101 being configured to, using the provisioning service 418, to render the candidate route mapping 416 on the real-time view of the graphical user interface 420. Additionally, or alternatively, initiating an update to a real-time view of the graphical user interface 420 based on the candidate route mapping 416 comprises the computing system 101 being configured to, using the provisioning service 418, update the candidate route mapping 416 rendered on the graphical user interface 420. For example, if a first user is traveling to a second user location using a path indicated by a navigational instruction, the candidate route mapping 416 may be updated in real-time to display a representation of the first user location as the first user travels along the path (e.g., a representation of the first user location on the candidate route mapping 416 may move as the first user location moves). As another example, if a route segment along a path that a first user is travelling is impacted by a navigational feature, the candidate route mapping 416 may be updated in real-time to display a representation of the route segment and/or the navigational feature. As another example, as a first user travels to a second user location, the candidate route mapping 416 may be updated to update a time associated with a navigational instruction (e.g., the time may be decreased as a first user gets closer to a second user location and/or increase if a route segment being used by a first user to travel to a second user location is impacted by a navigational feature).

In some embodiments, the computing system 101, using the provisioning service 418 of the routing pipeline 422 for the graphical user interface 420, receives modification data 408 from one or more of a plurality of users and/or one or more of the data sources 402. In some embodiments, modification data 408 comprises one or more items of data that may be input into the routing pipeline 422 to generate the candidate route mapping 416. In some embodiments, modification data 408 comprises at least one modification to the input data 406. In this regard, in some embodiments, the modification data 408 comprises one or more items of data indicative of at least one modification to one or more temporal features, geographic features, navigation features, user features, and/or entity features. In some embodiments, the modification data 408 is configured in a natural language format. For example, the modification data 408 may comprise a segment of text, such as “a first user is no longer available at a first time and is now available at a second time.” Additionally, or alternatively, the modification data 408 is configured in a numerical format. For example, the modification data 408 may comprise one or more numbers that indicate the availability of a first user “11-5 ” when the input data 406 indicated that the availability of the first user was “9-5”. Additionally, or alternatively, the modification data 408 is configured in a tabular format. For example, the modification data 408 may comprise a table having one or more data fields indicating an updated availability of a first user.

In some embodiments, the computing system 101, using the encoding service 410 of the routing pipeline 422 for the graphical user interface 420, generates second encoded data by transforming the modification data into a second set of input vectors for the optimization service. In some embodiments, the computing system 101, using the encoding service 410 of the routing pipeline 422 for the graphical user interface 420, generates an updated candidate route mapping by applying the set of weighted hard parameters 428 and the set of weighted soft parameters 430 to the encoded data 412 and the second encoded data. In some embodiments, the computing system 101, using the provisioning service 418 of the routing pipeline 422 for the graphical user interface 420, initiates a second update to a real-time view of the graphical user interface 420 based on the updated candidate route mapping. In this regard, in some embodiments, the computing system 101, using the routing pipeline 422 is configured to receive real-time modifications associated with a candidate route mapping and update the candidate route mapping 416 in real-time based on the modifications.

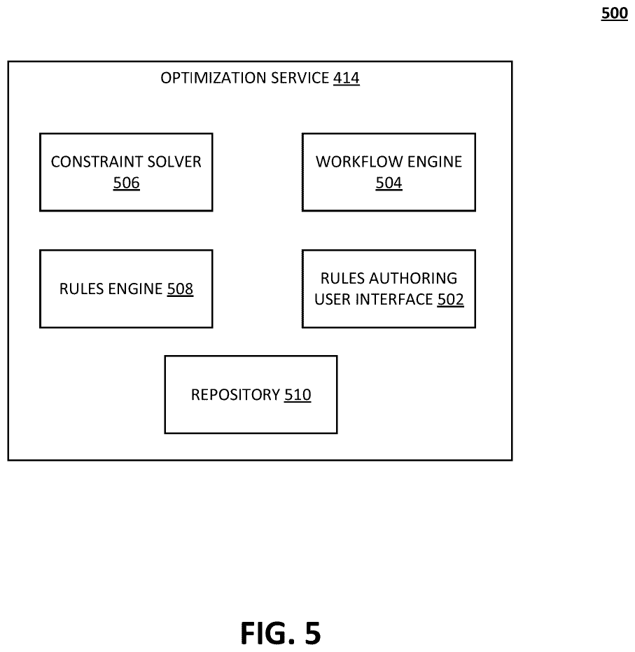

FIG. 5 is an operational example 500 of an example architecture of the optimization service 414 in accordance with some embodiments of the present disclosure. As shown in the operational example 500, the optimization service 414 may comprise a rules authoring user interface 502. In some embodiments, the rules authoring user interface 502 may be used to provide routing constraints 424 and/or the enterprise constraints 426 to the routing pipeline 422. In this regard, for example, the optimization service 414 may receive the routing constraints 424 and/or the enterprise constraints 426. As shown in the operational example 500, the optimization service 414 may comprise a workflow engine 504. In some embodiments, the workflow engine manages one or more processes of the optimization service, receives reports from one or more computing devices external to the routing pipeline 422, and/or provides one or more reports to one or more computing devices external to the routing pipeline 422. As shown in the operational example 500, the optimization service 414 may comprise a constraint solver 506 that generates the candidate route mapping 416 based on the set of weighted hard parameters 428 and/or the set of weighted soft parameters 430. In some embodiments, the constraint solver 506 uses rules-based and/or machine learning techniques. For example, the constraint solver 506 may be implemented in Optaplanner, Timefold, Localsolver, Gurobi, and/or the like. As shown in the operational example 500, the optimization service 414 may comprise a rules engine 508. In some embodiments, the rules engine 508 is configured to operate the constraint solver 506. As shown in the operational example 500, the optimization service 414 may comprise a repository 510 configured to store data associated with the optimization service 414. For example, the repository 510 may store the set of weighted hard parameters 428 and/or the set of weighted soft parameters 430.

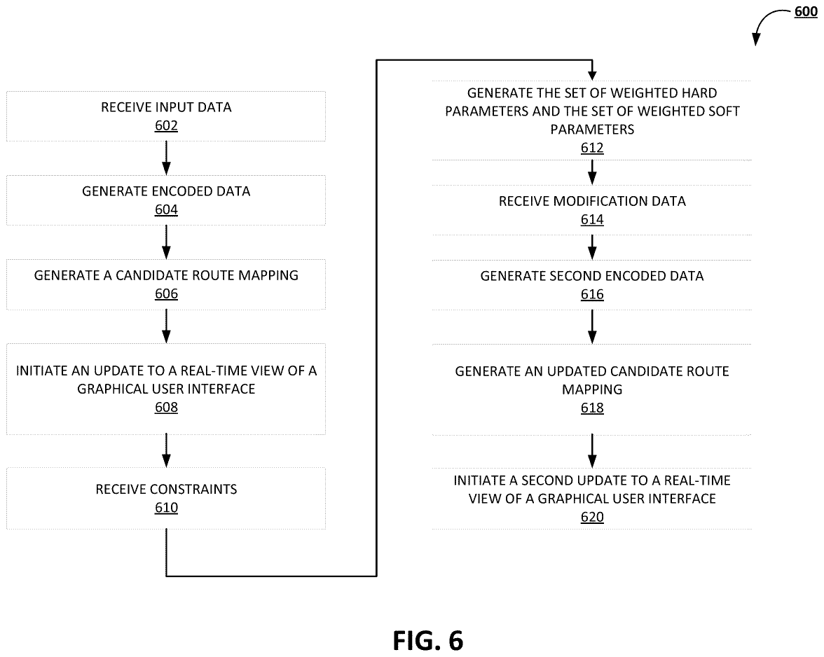

FIG. 6 is a flowchart diagram of an example autonomous encoding and candidate route mapping process 600 in accordance with some embodiments of the present disclosure. The flowchart diagram depicts an autonomous encoding and candidate route mapping process that is performed using a multi-stage routing pipeline that takes a variety of inputs from multiple sources. The process 600 may be implemented by one or more computing devices, entities, and/or systems described herein. For example, via the various steps/operations of the process 600, the computing system 101 may automatically encode input data, generate a candidate route mapping, and initiate an update to a real-time view of a graphical user interface. By doing so, the process 600 improve computer functionality by improving the performance of downstream services of a routing pipeline such that the routing pipeline may be directly integrated with a user interface. This, in turn, enables improved candidate route mapping that, unlike traditional techniques, may handle inputs in different formats from a variety of competing data sources, maintain a high degree of accuracy in candidate route mappings, and limit latency associated with the graphical user interface.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 comprises, at step/operation 602, receiving input data. For example, the computing system 101 may receive, by one or more processors and using a data collection service of a routing pipeline for a graphical user interface, input data from one or more of a plurality of data sources.

In some embodiments, the process 600 comprises, at step/operation 604, generating encoded data. For example, the computing system 101 may generate, by the one or more processors and using an encoding service of the routing pipeline for the graphical user interface, encoded data by transforming the input data into a set of input vectors for an optimization service of the routing pipeline.

In some embodiments, the process 600 comprises, at step/operation 606, generate a candidate route mapping. For example, the computing system 101 may generate, by the one or more processors and using the optimization service for the graphical user interface, a candidate route mapping by applying a set of weighted hard parameters and a set of weighted soft parameters to the encoded data. In some embodiments (i) the set of weighted hard parameters comprises a first constraint combination of (a) a plurality of enterprise constraints and (b) a plurality of routing constraints and (ii) the set of weighted soft parameters comprises a second combination of (a) the plurality of enterprise constraints and (b) the plurality of routing constraints. In some embodiments, the candidate route mapping comprises (i) a navigational instruction, (ii) a first user identifier corresponding to a first user of a plurality of users, and (iii) a time corresponding to the navigational instruction. In some embodiments, the candidate route mapping comprises a second user identifier that corresponds to a second user of the plurality of users and the navigational instruction identifies a path between a first user location of the first user and a second user location of the second user.

In some embodiments, the process 600 comprises, at step/operation 608, initiating an update to a real-time view of a graphical user interface. For example, the computing system 101 may initiate by the one or more processors and using a provisioning service of the routing pipeline for the graphical user interface, an update to a real-time view of the graphical user interface based on the candidate route mapping.

In some embodiments, the process 600 comprises, at step/operation 610, receiving constraints. For example, the computing system 101 may receive the plurality of enterprise constraints and the plurality of routing constraints.

In some embodiments, the process 600 comprises, at step/operation 612, generating the set of weighted hard parameters and the set of weighted soft parameters. For example, the computing system 101 may generate the set of weighted hard parameters and the set of weighted soft parameters by applying a weight to up to each of the plurality of enterprise constraints and the plurality of routing constraints.

In some embodiments, the process 600 comprises, at step/operation 614, receiving modification data. For example, the computing system 101 may receive modification data from one or more of a plurality of users or one or more of the plurality of data sources.

In some embodiments, the process 600 comprises, at step/operation 616, generating second encoded data. For example, the computing system 101 may generate second encoded data by transforming the modification data into a second set of input vectors for the optimization service.

In some embodiments, the process 600 comprises, at step/operation 618, generating an updated candidate route mapping. For example, the computing system 101 may generate an updated candidate route mapping by applying the set of weighted hard parameters and the set of weighted soft parameters to the encoded data and the second encoded data.

In some embodiments, the process 600 comprises, at step/operation 620, initiating a second update to a real-time view of a graphical user interface. For example, the computing system 101 may initiate a second update to the real-time view of the graphical user interface based on the updated candidate route mapping.

Some techniques of the present disclosure enable the generation of action outputs that may be performed to initiate one or more real world actions to achieve real-world effects. The techniques of the present disclosure may be used, applied, and/or otherwise leveraged to initiate updates to a real-time view of a graphical user interface, provide audible alerts (e.g., related to a navigational instructions, and/or the like. In some examples, the candidate route mapping of the present disclosure may trigger action outputs (e.g., through control instructions) to automate routing pipeline process and/or the like. The action outputs may control various aspects of a client device, such as the display, transmission, and/or the like of data reflective of an alert, and/or the like. The alert may be automatically communicated to a user and/or may be used to initiate a candidate route mapping, actuation of a device associated with a first user or a second user, a security protocol (e.g., locking a computer), a robotic action (e.g., performing an autonomous encoding process), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as comprising logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X, and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model comprising one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform all of the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising receiving, by one or more processors and using a data collection service of a routing pipeline for a graphical user interface, input data from one or more of a plurality of data sources; generating, by the one or more processors and using an encoding service of the routing pipeline for the graphical user interface, encoded data by transforming the input data into a set of input vectors for an optimization service of the routing pipeline; generating, by the one or more processors and using the optimization service for the graphical user interface, a candidate route mapping by applying a set of weighted hard parameters and a set of weighted soft parameters to the encoded data, wherein (i) the set of weighted hard parameters comprises a first constraint combination of (a) a plurality of enterprise constraints and (b) a plurality of routing constraints and (ii) the set of weighted soft parameters comprises a second combination of (a) the plurality of enterprise constraints and (b) the plurality of routing constraints; and initiating, by the one or more processors and using a provisioning service of the routing pipeline for the graphical user interface, an update to a real-time view of the graphical user interface based on the candidate route mapping.

Example 2. The computer-implemented method of example 1, wherein the candidate route mapping comprises (i) a navigational instruction, (ii) a first user identifier corresponding to a first user of a plurality of users, and (iii) a time corresponding to the navigational instruction.

Example 3. The computer-implemented method of example 2, wherein the candidate route mapping comprises a second user identifier that corresponds to a second user of the plurality of users and the navigational instruction identifies a path between a first user location of the first user and a second user location of the second user.

Example 4. The computer-implemented method of any of the preceding claims, further comprising receiving the plurality of enterprise constraints and the plurality of routing constraints; and generating the set of weighted hard parameters and the set of weighted soft parameters by applying a weight to each of the plurality of enterprise constraints and the plurality of routing constraints.

Example 5. The computer-implemented method of any of the preceding claims, further comprising receiving modification data from one or more of a plurality of users or one or more of the plurality of data sources; generating second encoded data by transforming the modification data into a second set of input vectors for the optimization service; generating an updated candidate route mapping by applying the set of weighted hard parameters and the set of weighted soft parameters to the encoded data and the second encoded data; and initiating a second update to the real-time view of the graphical user interface based on the updated candidate route mapping.

Example 6. The computer-implemented method of any of the preceding claims, wherein generating the encoded data comprises extracting a temporal feature from the input data, wherein the temporal feature is associated with a first user of a plurality of users; generating a normalized temporal feature by converting the temporal feature to a temporal format; generating a plurality of indicators based on the normalized temporal feature, wherein the plurality of indicators comprises a set of positive indicators and a set of negative indicators; and generating a first input vector of the set of input vectors, wherein the first input vector comprises the set of positive indicators and the set of negative indicators.

Example 7. The computer-implemented method of any of the preceding claims, wherein generating the encoded data comprises extracting a first temporal feature, a second temporal feature, and a geographic feature from the input data; applying a first identifier to the first temporal feature and a second identifier to the second temporal feature; generating a geographic value based on the geographic feature; and generating a first input vector of the set of input vectors, wherein the first input vector comprises a first tuple comprising the first identifier and the geographic value and a second tuple comprising the second identifier and the geographic value.

Example 8. The computer-implemented method of any of the preceding claims, wherein generating the encoded data comprises extracting a navigation feature and a geographic feature from the input data; applying a navigation code to the navigation feature; determining a route segment associated with the geographic feature; and generating a first input vector of the set of input vectors, wherein the first input vector comprises the navigation code and the route segment.

Example 9. The computer-implemented method of any of the preceding claims, wherein generating the encoded data comprises extracting a first user feature and a second user feature from the input data, wherein the first user feature and the second user feature are associated with a first user of a plurality of users; applying a first workflow code to the first user feature and a second workflow code to the second user feature; and generating a first input vector of the set of input vectors, wherein the first input vector comprises the first workflow code and the second workflow code.

Example 10. The computer-implemented method of any of the preceding claims, wherein generating the encoded data comprises extracting an entity feature and a temporal feature associated with the entity feature from the input data; generating a temporal value for the entity feature by applying a temporal unit to the temporal feature; and generating a first input vector of the set of input vectors, wherein the first input vector comprises the entity feature and the temporal value.

Example 11. The computer-implemented method of any of the preceding claims, wherein generating the encoded data comprises extracting a user feature and a temporal feature associated with the user feature from the input data; generating a temporal code based on the temporal feature; generating a user code based on the user feature; and generating a first input vector of the set of input vectors, wherein the first input vector comprises the temporal code and the user code.

Example 12. A system comprising: one or more processors; and one or more memories storing processor-executable instructions that, when executed by the one or more processors, cause the one or more processors to perform operations comprising receiving, using a data collection service of a routing pipeline for a graphical user interface, input data from one or more of a plurality of data sources; generating, using an encoding service of the routing pipeline for the graphical user interface, encoded data by transforming the input data into a set of input vectors for an optimization service of the routing pipeline; generating, using the optimization service for the graphical user interface, a candidate route mapping by applying a set of weighted hard parameters and a set of weighted soft parameters to the encoded data, wherein (i) the set of weighted hard parameters comprises a first constraint combination of (a) a plurality of enterprise constraints and (b) a plurality of routing constraints and (ii) the set of weighted soft parameters comprises a second combination of (a) the plurality of enterprise constraints and (b) the plurality of routing constraints; and initiating, using a provisioning service of the routing pipeline for the graphical user interface, an update to a real-time view of the graphical user interface based on the candidate route mapping.

Example 13. The system of example 12, wherein the candidate route mapping comprises (i) a navigational instruction, (ii) a first user identifier corresponding to a first user of a plurality of users, and (iii) a time corresponding to the navigational instruction.

Example 14. The system of example 13, wherein the candidate route mapping comprises a second user identifier that corresponds to a second user of the plurality of users and the navigational instruction identifies a path between a first user location of the first user and a second user location of the second user.

Example 15. The system of examples 12-14, further comprising receiving the plurality of enterprise constraints and the plurality of routing constraints; and generating the set of weighted hard parameters and the set of weighted soft parameters by applying a weight to each of the plurality of enterprise constraints and the plurality of routing constraints.

Example 16. The system of examples 12-15, further comprising receiving modification data from one or more of a plurality of users or one or more of the plurality of data sources; generating second encoded data by transforming the modification data into a second set of input vectors for the optimization service; generating an updated candidate route mapping by applying the set of weighted hard parameters and the set of weighted soft parameters to the encoded data and the second encoded data; and initiating a second update to the real-time view of the graphical user interface based on the updated candidate route mapping.

Example 17. One or more non-transitory computer-readable media storing processor-executable instructions that, when executed by one or more processors, cause the one or more processors to perform operations comprising receiving, using a data collection service of a routing pipeline for a graphical user interface, input data from one or more of a plurality of data sources; generating, using an encoding service of the routing pipeline for the graphical user interface, encoded data by transforming the input data into a set of input vectors for an optimization service of the routing pipeline; generating, using the optimization service for the graphical user interface, a candidate route mapping by applying a set of weighted hard parameters and a set of weighted soft parameters to the encoded data, wherein (i) the set of weighted hard parameters comprises a first constraint combination of (a) a plurality of enterprise constraints and (b) a plurality of routing constraints and (ii) the set of weighted soft parameters comprises a second combination of (a) the plurality of enterprise constraints and (b) the plurality of routing constraints; and initiating, using a provisioning service of the routing pipeline for the graphical user interface, an update to a real-time view of the graphical user interface based on the candidate route mapping.

Example 18. The one or more non-transitory computer-readable media of example 17, wherein the candidate route mapping comprises (i) a navigational instruction, (ii) a first user identifier corresponding to a first user of a plurality of users, and (iii) a time corresponding to the navigational instruction.

Example 19. The one or more non-transitory computer-readable media of example 18, wherein the candidate route mapping comprises a second user identifier that corresponds to a second user of the plurality of users and the navigational instruction identifies a path between a first user location of the first user and a second user location of the second user.

Example 20. The one or more non-transitory computer-readable media of examples 17-19, further comprising receiving the plurality of enterprise constraints and the plurality of routing constraints; and generating the set of weighted hard parameters and the set of weighted soft parameters by applying a weight to each of the plurality of enterprise constraints and the plurality of routing constraints.

1. A computer-implemented method comprising:
receiving, by one or more processors and using a data collection service of a routing pipeline for a graphical user interface, input data from one or more of a plurality of data sources;
generating, by the one or more processors and using an encoding service of the routing pipeline for the graphical user interface, encoded data by transforming the input data into a set of input vectors for an optimization service of the routing pipeline;
generating, by the one or more processors and using the optimization service for the graphical user interface, a candidate route mapping by applying a set of weighted hard parameters and a set of weighted soft parameters to the encoded data, wherein (i) the set of weighted hard parameters comprises a first constraint combination of (a) a plurality of enterprise constraints and (b) a plurality of routing constraints and (ii) the set of weighted soft parameters comprises a second combination of (a) the plurality of enterprise constraints and (b) the plurality of routing constraints; and
initiating, by the one or more processors and using a provisioning service of the routing pipeline for the graphical user interface, an update to a real-time view of the graphical user interface based on the candidate route mapping.

2. The computer-implemented method of claim 1, wherein the candidate route mapping comprises (i) a navigational instruction, (ii) a first user identifier corresponding to a first user of a plurality of users, and (iii) a time corresponding to the navigational instruction.

3. The computer-implemented method of claim 2, wherein the candidate route mapping comprises a second user identifier that corresponds to a second user of the plurality of users and the navigational instruction identifies a path between a first user location of the first user and a second user location of the second user.

4. The computer-implemented method of claim 1, further comprising:
receiving the plurality of enterprise constraints and the plurality of routing constraints; and
generating the set of weighted hard parameters and the set of weighted soft parameters by applying a weight to each of the plurality of enterprise constraints and the plurality of routing constraints.

5. The computer-implemented method of claim 1, further comprising:
receiving modification data from one or more of a plurality of users or one or more of the plurality of data sources;
generating second encoded data by transforming the modification data into a second set of input vectors for the optimization service;
generating an updated candidate route mapping by applying the set of weighted hard parameters and the set of weighted soft parameters to the encoded data and the second encoded data; and
initiating a second update to the real-time view of the graphical user interface based on the updated candidate route mapping.

6. The computer-implemented method of claim 1, wherein generating the encoded data comprises:
extracting a temporal feature from the input data, wherein the temporal feature is associated with a first user of a plurality of users;
generating a normalized temporal feature by converting the temporal feature to a temporal format;
generating a plurality of indicators based on the normalized temporal feature, wherein the plurality of indicators comprises a set of positive indicators and a set of negative indicators; and
generating a first input vector of the set of input vectors, wherein the first input vector comprises the set of positive indicators and the set of negative indicators.

7. The computer-implemented method of claim 1, wherein generating the encoded data comprises:
extracting a first temporal feature, a second temporal feature, and a geographic feature from the input data;
applying a first identifier to the first temporal feature and a second identifier to the second temporal feature;
generating a geographic value based on the geographic feature; and
generating a first input vector of the set of input vectors, wherein the first input vector comprises a first tuple comprising the first identifier and the geographic value and a second tuple comprising the second identifier and the geographic value.

8. The computer-implemented method of claim 1, wherein generating the encoded data comprises:
extracting a navigation feature and a geographic feature from the input data;
applying a navigation code to the navigation feature;
determining a route segment associated with the geographic feature; and
generating a first input vector of the set of input vectors, wherein the first input vector comprises the navigation code and the route segment.

9. The computer-implemented method of claim 1, wherein generating the encoded data comprises:
extracting a first user feature and a second user feature from the input data, wherein the first user feature and the second user feature are associated with a first user of a plurality of users;
applying a first workflow code to the first user feature and a second workflow code to the second user feature; and
generating a first input vector of the set of input vectors, wherein the first input vector comprises the first workflow code and the second workflow code.

10. The computer-implemented method of claim 1, wherein generating the encoded data comprises:
extracting an entity feature and a temporal feature associated with the entity feature from the input data;
generating a temporal value for the entity feature by applying a temporal unit to the temporal feature; and
generating a first input vector of the set of input vectors, wherein the first input vector comprises the entity feature and the temporal value.

11. The computer-implemented method of claim 1, wherein generating the encoded data comprises:
extracting a user feature and a temporal feature associated with the user feature from the input data;
generating a temporal code based on the temporal feature;
generating a user code based on the user feature; and
generating a first input vector of the set of input vectors, wherein the first input vector comprises the temporal code and the user code.

12. A system comprising:
one or more processors; and
one or more memories storing processor-executable instructions that, when executed by the one or more processors, cause the one or more processors to perform operations comprising:
receiving, using a data collection service of a routing pipeline for a graphical user interface, input data from one or more of a plurality of data sources;
generating, using an encoding service of the routing pipeline for the graphical user interface, encoded data by transforming the input data into a set of input vectors for an optimization service of the routing pipeline;
generating, using the optimization service for the graphical user interface, a candidate route mapping by applying a set of weighted hard parameters and a set of weighted soft parameters to the encoded data, wherein (i) the set of weighted hard parameters comprises a first constraint combination of (a) a plurality of enterprise constraints and (b) a plurality of routing constraints and (ii) the set of weighted soft parameters comprises a second combination of (a) the plurality of enterprise constraints and (b) the plurality of routing constraints; and
initiating, using a provisioning service of the routing pipeline for the graphical user interface, an update to a real-time view of the graphical user interface based on the candidate route mapping.

13. The system of claim 12, wherein the candidate route mapping comprises (i) a navigational instruction, (ii) a first user identifier corresponding to a first user of a plurality of users, and (iii) a time corresponding to the navigational instruction.

14. The system of claim 13, wherein the candidate route mapping comprises a second user identifier that corresponds to a second user of the plurality of users and the navigational instruction identifies a path between a first user location of the first user and a second user location of the second user.

15. The system of claim 12, wherein the operations further comprise:
receiving the plurality of enterprise constraints and the plurality of routing constraints; and
generating the set of weighted hard parameters and the set of weighted soft parameters by applying a weight to each of the plurality of enterprise constraints and the plurality of routing constraints.

16. The system of claim 12, wherein the operations further comprise:
receiving modification data from one or more of a plurality of users or one or more of the plurality of data sources;
generating second encoded data by transforming the modification data into a second set of input vectors for the optimization service;
generating an updated candidate route mapping by applying the set of weighted hard parameters and the set of weighted soft parameters to the encoded data and the second encoded data; and
initiating a second update to the real-time view of the graphical user interface based on the updated candidate route mapping.

17. One or more non-transitory computer-readable media storing processor-executable instructions that, when executed by one or more processors, cause the one or more processors to perform operations comprising:
receiving, using a data collection service of a routing pipeline for a graphical user interface, input data from one or more of a plurality of data sources;
generating, using an encoding service of the routing pipeline for the graphical user interface, encoded data by transforming the input data into a set of input vectors for an optimization service of the routing pipeline;
generating, using the optimization service for the graphical user interface, a candidate route mapping by applying a set of weighted hard parameters and a set of weighted soft parameters to the encoded data, wherein (i) the set of weighted hard parameters comprises a first constraint combination of (a) a plurality of enterprise constraints and (b) a plurality of routing constraints and (ii) the set of weighted soft parameters comprises a second combination of (a) the plurality of enterprise constraints and (b) the plurality of routing constraints; and
initiating, using a provisioning service of the routing pipeline for the graphical user interface, an update to a real-time view of the graphical user interface based on the candidate route mapping.

18. The one or more non-transitory computer-readable storage media of claim 17, wherein the candidate route mapping comprises (i) a navigational instruction, (ii) a first user identifier corresponding to a first user of a plurality of users, and (iii) a time corresponding to the navigational instruction.

19. The one or more non-transitory computer-readable storage media of claim 18, wherein the candidate route mapping comprises a second user identifier that corresponds to a second user of the plurality of users and the navigational instruction identifies a path between a first user location of the first user and a second user location of the second user.

20. The one or more non-transitory computer-readable storage media of claim 17, wherein the operations further comprise:
receiving the plurality of enterprise constraints and the plurality of routing constraints; and
generating the set of weighted hard parameters and the set of weighted soft parameters by applying a weight to each of the plurality of enterprise constraints and the plurality of routing constraints.
